(19) United States
(12) Patent Application Publication
(10) Pub. No.: US 2008/0249779 A1
(43) Pub. Date: Oct. 9, 2008

(54) SPEECH DIALOG SYSTEM

(76) Inventor: Marcus Hennecke, Graz (AT)

Correspondence Address: BRINKS HOFER GILSON & LIONE, P.O. BOX 10395, CHICAGO, IL, 60610, US

(21) Appl. No.: 11/932,355

(22) Filed: Oct. 31, 2007

Related U.S. Application Data
(63) Continuation-in-part of application No. 10/562,355, filed on Oct. 10, 2006.

(30) Foreign Application Priority Data
Jun. 30, 2003 (EP) 03 014 845.6
Jun. 30, 2003 (EP) 03014845.6

(51) Int. Cl. G10L 21/00

(52) U.S. Cl. 704/270; 704/E21.001

(57) ABSTRACT

A speech dialog system includes a signal input unit that receives an acoustic input signal. A voice activity detector compares a portion of the received signal to a noise estimate to determine if the signal includes voice activity. A speech recognizer processes signals containing voice activity to determine if the signal contains speech. An output unit modifies signals when output of the system substantially coincides with the delivered speech.

### PRIORITY CLAIM

This application is a continuation-in-part of U.S. patent application Ser. No. 10/562,355, filed Dec. 27, 2005, which claims the benefit of priority from PCT Application No. PCT/EP2004/007115, filed Jun. 30, 2004, which claims the benefit of priority from European Patent Application No. 03014845.6, filed Jun. 30, 2003, both of which are incorporated by reference.

### BACKGROUND OF THE INVENTION

1. Technical Field

The invention relates to a system for controlling a speech dialog system, and more particularly, to a speech dialog system having a robust barge-in feature.

2. Related Art

A speech dialog system may receive a speech signal and may recognize various words or commands. The system may engage a user in a dialog to elicit information to perform a task, such as placing an order, controlling a device, or performing another task. Some systems may include a feature that allows a user to interrupt the system to speed up a dialog. These systems may misinterpret non-speech signal as speech even though the user has not spoken. Therefore, there is a need for an improved speech dialog system that is more sensitive to non-speech signals and alters a system output when speech is detected.

### SUMMARY

A speech dialog system includes a signal input unit that receives an acoustic input. A voice activity detector compares a portion of the received signal to a noise estimate to detect voice activity. A speech recognizer processes input signals containing the voice activity to detect speech. An output unit modifies an output signal at substantially the same rate that speech is detected.

Other systems, methods, features and advantages of the invention will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

The system may be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is a block diagram of a speech dialog system.

FIG. 2 is a flow diagram of a method of controlling a speech dialog system.

FIG. 3 is a flow diagram of a method of providing a barge-in feature for a speech dialog system.

FIG. 4 is a speech dialog system within a vehicle.

FIG. 5 is a speech dialog system interfaced to a communication system.

FIG. 6 is a block diagram of a speech input unit.

FIG. 7 is a block diagram of an alternate speech input unit.

FIG. 8 is a block diagram of a second alternate speech input unit.

FIG. 9 is a block diagram of a third alternate speech input unit.

### DETAILED DESCRIPTION OF THE PREFERRED EMBODIMENTS

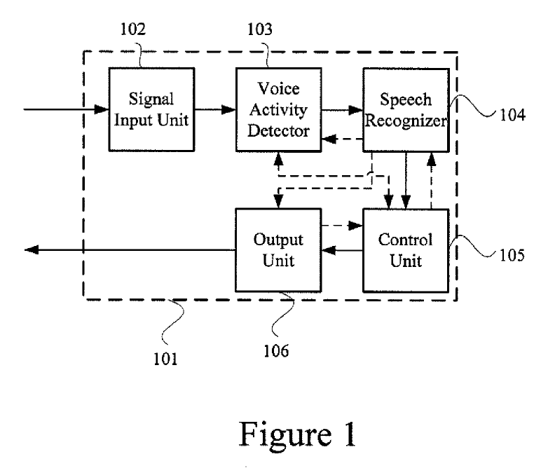

FIG. 1 is a block diagram of a speech dialog system 101. The speech dialog system 101 includes a signal input unit 102, a voice activity detector 103, a speech recognizer 104, a control unit 105, and an output unit 106. The signal input unit 102 may comprise a device or sensor that converts acoustic signals into analog or digital data. A voice activity detector 103 analyzes the signals to determine whether the voice activity is present. Voice activity may comprise speech or non-speech sounds. In some systems, voice activity may be detected when a significant energy exists above a predetermined or preprogrammed threshold. The threshold may be selected such that if the signal includes energy above that threshold, the signal is likely to include speech or non-speech sounds rather than background noise. Some voice activity detectors 103 may detect voice activity by comparing some or all of a received signal's spectrum with one or more noise estimates stored in a local internal memory or a remote external memory. The noise estimate may be adaptively updated during detected pauses in a received signal to improve performance.

When voice activity is detected, a signal is delivered to the speech recognizer 104. The speech recognizer 104 processes the signal to determine if speech components are present by loading speech models, pause models, and/or grammar rules from model and grammar rule databases into a local operating memory. Through iterative comparisons of the received signal to allowed speech (e.g., identified by models and rules), the speech recognizer 104 may detect speech components. If the voice activity detector 104 detects voice activity in some circumstances when there is no speech, a pause model may correctly identify the received signal. If a speech signal is present, one or more speech models may its identity. In these systems, the speech recognizer 104 may detect speech by determining which models provide the best match or correlation with the received signal.

The speech recognizer 104 may have different configurations depending on a speech dialog system application. The speech recognizer 104 may detect single words (e.g., an isolated word recognizer) or may detect multiple words or phrases (e.g., a compound word recognizer). Some speech recognizers 104 may identify speech based on pre-trained speaker-dependent models while other speech recognizers may identify speech independent of a speaker models. Some speech recognizers 204 may use statistical and/or structural pattern recognition techniques, expert systems, and/or knowledge based (phonetic and linguistic) principles. Statistical pattern recognition may include Hidden Markov Models (HMM) and/or artificial neural networks (ANN). These statistical and/or structural pattern recognition systems may generate probabilities and/or confidence levels of recognized words and/or phrases. Such speech recognition techniques may provide different approaches for detecting speech. For example, path probabilities of the pause and/or speech models, or the number of pause and/or speech paths can be compared to modeled data. Confidence levels may also be considered, or the number of recognized words may be compared to a predetermined or preprogrammed threshold. In some systems a fixed or variable code book may be used. The systems may be linked in many ways. In some applications identified results may be transmitted to a classification device that evaluates the results and decides whether speech is detected. Some systems wait for a predetermined or preprogrammed time period (for example, about 0.5 s) to determine a tendency that indicates whether speech is present.

An output unit 106 generates aural signals such as synthesized voice prompts. Speech templates may be stored locally in a playing unit or a memory which may reside within or remote from the speech dialog system. Some playing units comprise a speech synthesizer that synthesizes desired output signals. The signals may be converted into audible sound. If a signal generated by the speech recognizer 104 indicating the presence of speech in an acoustic input signal is received at the output unit 106 while a signal is converted into an audible sound, the signal output may be farther processed or modified. The additional processing or modification may reduce the amplification or volume of the output signal or completely dampen or attenuate the output signal. The speech recognizer 104 may be coupled to a control unit 105 as shown in FIG. 1.

The control unit 105 may control the operation of the speech recognizer 104 and the output unit 105. In some systems, the control unit 105 may transmit an activation signal to the speech recognizer 104 when the system is energized or reset. In response, the speech recognizer 104 may transmit an activation signal to the voice activity detector 103 which may detect voice activity in incoming signals. In some systems, the control unit 105 may also transmit an initiation signal to the output unit 106 when the control unit 105 is energized or reset. The initiation signal may activate the transmission of an interstitial signal that may be converted to audible sound. Some systems may respond by generating or transmitting a greeting such as “Welcome to the automatic information system.”

When the speech recognizer 104 recognizes speech within an input signal, the recognized speech may be transmitted to the control unit 105. The control unit 105 may provide appropriate control to one or more local or remote systems or applications. The systems or applications may include telephony; data entry; vehicle, driver, or passenger comfort control; games and entertainment; document generation and editing; and/or other speech recognition applications.

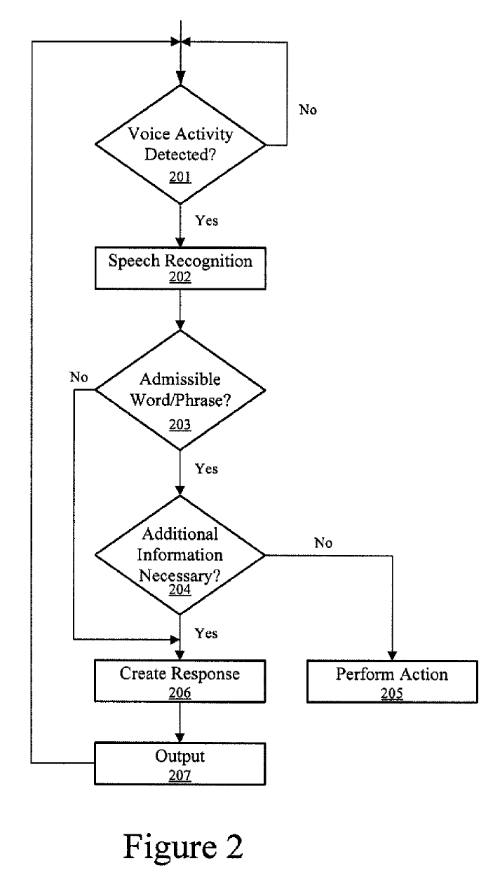

FIG. 2 is a flow diagram that may control a speech dialog system. At act 201, the speech dialog system determines whether an acoustic input signal includes voice activity. Voice activity may be detected when a significant energy exceeds a predetermined or preprogrammed threshold. The threshold may be programmed such that if the signal includes energy above the threshold, the signal is likely to include speech rather than noise. Alternatively, voice activity may be detected by comparing some or all of a received acoustic input signal's spectrum with a stored noise estimate. The noise estimate may be adaptively updated during detected pauses in the received acoustic input signal to improve performance. If voice activity is not detected, the system may not further process input signal. If voice activity is detected at act 201, the input signal is sent to a speech recognizer. A speech recognizer identifies speech in the received signal at act 202. Identification may include comparing some or all of the received signal to one or more speech and/or pause models.

At act 203 the process determines whether any recognized speech components correspond to admissible words and/or phrases. The admissibility of words and/or phrases may be based on contextual information stored in a rules database. Certain words and/or phrases may be inadmissible depending on which rule set is active. If the speech dialog system is part of an in-vehicle system, such as an audio system; climate control system; navigation system; and/or a wireless phone, the system send the user a series of menus that adjust or otherwise control one or more of the systems when speech is detected. Certain user commands may be recognized depending on the menu that is currently active. In-vehicle control systems may include top level menu terms such as, “audio,” “climate control,” “navigation,” and “wireless phone.” In some systems these terms might be the only admissible commands when a system is initialized. When a user issues an “audio” command, the menu associated with the in-vehicle audio system may be activated. When a user issues a “climate control” command, the menu associated with the in-vehicle climate control system may be activated. When a user issues a “navigation” command, the menu associated with the in-vehicle navigation system may be activated. When a user issues a “wireless phone” command, the menu associated with the in-vehicle telephone system may be activated. When a menu is active in an in-vehicle system, a term that is admissible in one menu may not be admissible in another. Thus, the context in which various words and/or phrases are received will determine the command's effect. If an admissible keyword is not detected at act 303, the speech dialog system generates a response at act 207. If a user has issued a “navigation system” command when the navigation menu is not accessible or the command includes an inadmissible keyword, the system may respond to the user in a context that the command was not recognized. In some systems, the response may be that “no navigation system is present” or that “the navigation system is not active.” In other systems, if a system determines that a command does not correspond to an admissible keyword, the system may prompt a user to “please repeat your command.” Some systems provide a list of admissible keywords or indexes, or other options available to the user at a particular time.

If the system detects an admissible keyword at act 203, the speech dialog system determines whether additional information is required at act 204 before a command or series of commands corresponding to the recognized speech is executed. In a speech dialog system linked to vehicle electronics, the system may recognizes an “audio” command. In some systems, the command may switch a vehicle radio between an active and inactive state. If the system detects a “wireless phone” command, additional information such as a name or number is required.

When additional information is not required, a control unit may transmit control data in response to recognized speech to one, two, or more systems or applications. The control data may be transmitted and performed in real-time or substantially real-time at act 205, before awaiting another input signal. A real-time operation may be an operation that matches a human perception of time or may be an activity that processes information at nearly the same rate or a faster rate as the information is received.

When the system requires additional information, the system may transmit a response, that renders a message such as “which number would you like to dial,” at act 206. The response may be sent through an audio or visual output device at act 207.

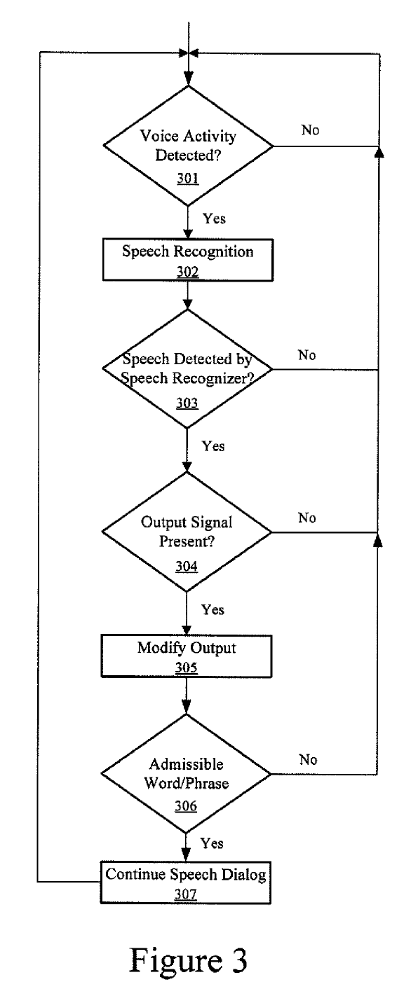

FIG. 3 is a flow diagram of a barge-in feature in a speech dialog system. The acts shown in FIG. 3 may be performed in real-time or substantially real-time and in parallel with the transmission of an output signal at act 207 in the method shown in FIG. 2. At act 301, a voice activity detector determines whether a received acoustic input signal includes voice activity. Voice activity may be detected when an amplitude within a programmed frequency range exceeds a programmed threshold. The threshold may be selected such that if amplitude exceeds a threshold, the signal is likely to include speech. Alternatively, voice activity may be detected by comparing some or all of a received acoustic input signal's spectrum with a stored noise estimate. The noise estimate may be adaptively updated during detected intervals, such as pauses in the acoustic input signal. If the voice activity is not detected, the system awaits another input signal. If voice activity is detected, the received signal is processed by a speech recognizer at act 302. Speech identification may include comparing some or all of the received signal to one or more speech models and/or pause models.

At act 303, the speech recognizer determines whether the signal comprises speech. If the speech recognizer does not detect speech components, the process awaits another input signal.

If the speech recognizer detects speech components, the process determines whether information is being transmitted by the system concurrently at act 304. If information is not being transmitted when speech is detected, the process analyzes the identified speech at act 306 to determine whether the speech corresponds to admissible words and/or phrases. If at act 304 the process determines that an output signal is being transmitted at or about the same time an input signal comprising speech is received by the system, the output signal is modified at act 305. The output signal may be modified in one, two, or more ways. If a speech signal is detected when a particular output message is transmitted, the volume or amplification of the message may be reduced. If a speech signal is detected for a predetermined time interval during the output may be interrupted or muted entirely. Some systems interrupt the output when a speech signal is detected at act 303 or according to other interrupt rules that may be stored in an internal memory or an external memory.

Once the output signal is modified, admissible words and/or phrases are processed at act 307. Processing of the admissible words and/or phrases may include transmitting control information or data from a control unit to one or more systems or applications coupled to the speech dialog system.

These processes may be encoded in a computer readable medium such as a memory, programmed within a device such as one or more integrated circuits, one or more processors or may be processed by a controller or a computer. If the processes are performed by software, the software may reside in a memory resident to or interfaced to a storage device, a communication interface, or non-volatile or volatile memory in communication with a transmitter. The memory may include an ordered listing of executable instructions for implementing logical functions. A logical function or any system element described may be implemented through optic circuitry, digital circuitry, through source code, through analog circuitry, or through an analog source, such as through an electrical, audio, or video signal. The software may be embodied in any computer-readable or signal-bearing medium, for use by, or in connection with an instruction executable system, apparatus, or device. Such a system may include a computer-based system, a processor-containing system, or another system that may selectively fetch instructions from an instruction executable system, apparatus, or device that may also execute instructions.

A “computer-readable medium,” “machine-readable medium,” “propagated-signal” medium, and/or “signal-bearing medium” may comprise any device that contains, stores, communicates, propagates, or transports software for use by or in connection with an instruction executable system, apparatus, or device. The machine-readable medium may selectively be, but not limited to, an electronic, magnetic, optical, electromagnetic, infrared, or semiconductor system, apparatus, device, or propagation medium. A non-exhaustive list of examples of a machine-readable medium would include: an electrical connection having one or more wires, a portable magnetic or optical disk, a volatile memory such as a Random Access Memory “RAM” (electronic), a Read-Only Memory “ROM” (electronic), an Erasable Programmable Read-Only Memory (EPROM or Flash memory) (electronic), or an optical fiber (optical). A machine-readable medium may also include a tangible medium upon which software is printed, as the software may be electronically stored as an image or in another format (e.g., through an optical scan), then compiled, and/or interpreted or otherwise processed. The processed medium may then be stored in a computer and/or machine memory.

Although selected aspects, features, or components of the implementations are described as being stored in memories, all or part of the systems, including processes and/or instructions for performing processes, consistent with the system may be stored on, distributed across, or read from other machine-readable media, for example, secondary storage devices such as hard disks, floppy disks, and CD-ROMs; a signal received from a network; or other forms of ROM or RAM resident to a processor or a controller.

Specific components of a system may include additional or different components. A controller may be implemented as a microprocessor, microcontroller, application specific integrated circuit (ASIC), discrete logic, or a combination of other types of circuits or logic. Similarly, memories may be DRAM, SRAM, Flash, or other types of memory. Parameters (e.g., conditions), databases, and other data structures may be separately stored and managed, may be incorporated into a single memory or database, or may be logically and physically organized in many different ways. Programs and instruction sets may be parts of a single program, separate programs, or distributed across several memories and processors.

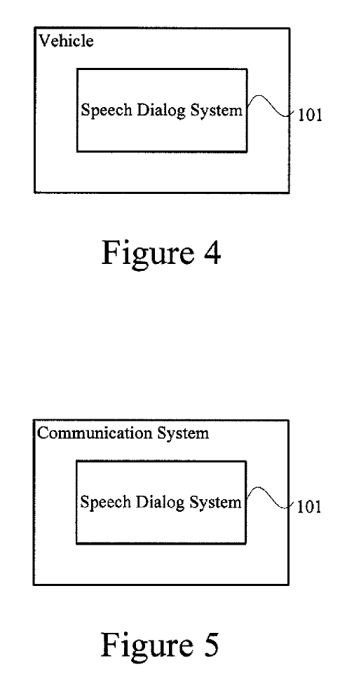

The speech dialog system is easily adaptable to various technologies and/or devices. Some speech dialog systems interface or couple vehicles as shown in FIG. 4. Other speech dialog systems may interface instruments that convert voice and other sounds into a form that may be transmitted to remote locations, such as landline and wireless telephones and/or audio equipment as shown in FIG. 5.

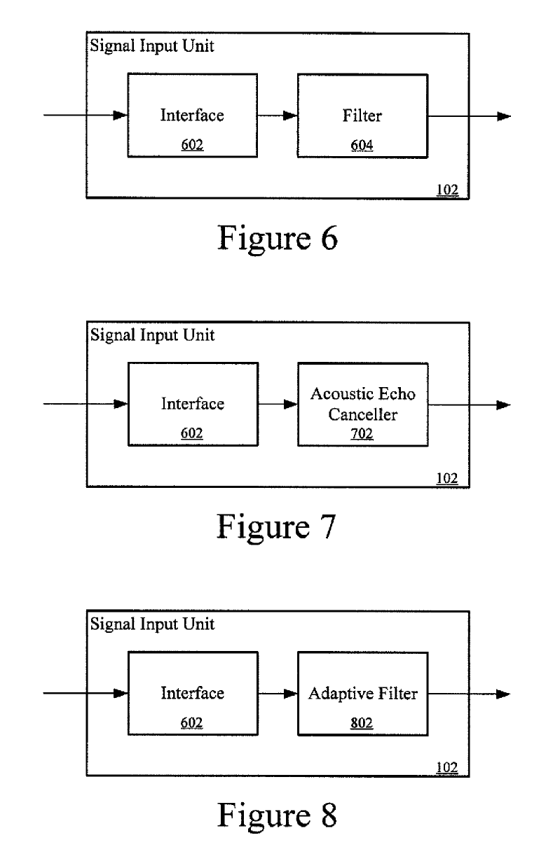

In some speech dialog systems, the signal input unit 102 may include various signal processing devices. In FIG. 6, the signal input unit 102 may comprise an interface device 602 that converts acoustic signals into analog or digital data. In some systems the interface device 602 may be a microphone and hardware that converts the microphone's output into analog, digital, or optical data at a programmed rate. Some signal interface devices 602 may process the received acoustic signals at the same rate as they are received. The interface device 602 output may be transmitted to one or more filters 604 to remove frequency components of the acoustic input signals that are outside of an audible range, such as frequencies less than about 20 Hz or greater than about 20 kHz. The one or more of the filters 604 may be a low pass, high pass, or bandpass filter. FIG. 7 is an alternate signal input unit 102. In FIG. 7, the interface device 602 output is transmitted to an acoustic echo canceller (AEC) 702 which suppresses acoustic reverberation and may suppress artifacts. FIG. 8 is a second alternate signal input unit. In FIG. 8, the interface device 602 output is transmitted to other types of noise reduction components 802, such as a Wiener filter, an adaptive Wiener filter, and/or other noise reduction hardware and/or software. Yet other signal input units may include feedback suppression circuitry which may reduce or substantially reduce the effects of signal feedback.

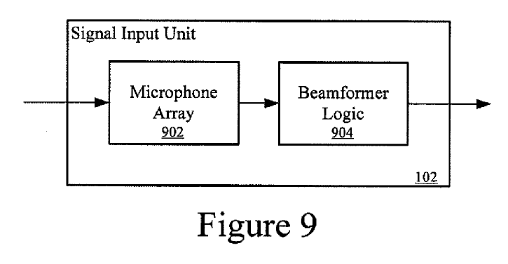

FIG. 9 is a third alternate signal input unit. In some speech dialog systems, the signal input unit 102 may comprise a microphone array 902 having multiple microphones spaced apart from one another. The signal input unit 102 may include beamformer logic 904 that process the signals generated by the microphone array 902. The beamformer logic 904 may exploit the lag time from direct and reflected signals arriving at different elements of the microphone array. Some beamformer logic 904 performs delay compensation and/or summing of the multiple signals received by the microphone array, applies weights to some or all of the microphone array signals to provide a specific directive pattern for the microphone array, and improves the signal-to-noise ratio of the microphone array signals by reducing or dampening noise such as background noise. Acoustic input signals received through the microphone array may be processed separately before the beamformer logic may operate on these signals to create a processed acoustic signal. Some or all of the components and/or devices of FIGS. 6-9 may be combined to form alternate configurations of a signal input unit 102.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

I claim:

1. A method of controlling a speech dialog system comprising:
receiving an acoustic input signal at an input device of a speech dialog system;
comparing a portion of the acoustic input signal with a stored noise estimate to determine if the acoustic input signal comprises voice activity;
comparing the portion of the acoustic input signal to a speech model and a pause model to determine if the acoustic input signal comprises speech, when it is determined that the acoustic input signal comprises voice activity; and
modifying an acoustic output signal provided by the speech dialog system when speech is detected in the acoustic input signal.

2. The method of claim 1 where modifying the acoustic output signal comprises reducing a volume level of the acoustic output signal.

3. The method of claim 1 where modifying the acoustic output signal comprises interrupting the acoustic output signal.

4. The method of claim 1 where the stored noise estimate is adaptively updated.

5. The method of claim 1 further comprising cancelling acoustic echo within the acoustic input signal.

6. The method of claim 1 further comprising reducing noise within the acoustic input signal.

7. The method of claim 1 further comprising suppressing feedback within the acoustic input signal.

8. The method of claim 1 where receiving an acoustic input signal comprises receiving a plurality of acoustic input signals at the input device, the input device comprising a microphone array.

9. The method of claim 9 further comprising combining the plurality of acoustic input signals into a single acoustic input signal.

10. The method of claim 9 where combining the plurality of acoustic input signals comprises beamforming the plurality of acoustic input signals.

11. A speech dialog system comprising:
a signal input unit that receives acoustic input signals;
a memory that stores noise estimates;
a voice activity detector that compares a portion of an acoustic input signal to the noise estimates to detect voice activity in the acoustic input signal;
a speech recognizer that compares the portion of the acoustic input signal having voice activity to speech models and pause models to detect speech in the acoustic input signal; and
an output unit that generates acoustic output signals in response to the acoustic input signals, where the output unit is adapted to modify the acoustic output signals when the speech recognizer detects speech in an acoustic input signal received during an output of the acoustic output signal.

12. The speech dialog system of claim 11 where the acoustic output signals comprise synthesized speech signals.

13. The speech dialog system of claim 11 where the output unit modifies the acoustic output signal by reducing a volume level of the acoustic output signal.

14. The speech dialog system of claim 11 where the output unit modifies the acoustic output signal by interrupting the acoustic output signal.

15. The speech dialog system of claim 11 further comprising a control unit, the control unit configured to transmit control signals to the output unit in response to information received from the speech recognizer.

16. The speech dialog system of claim 15, where the control signals comprise modification information when the information received from the speech recognizer indicates speech data is present in the acoustic input signal.

17. The speech dialog system of claim 11 where the signal input unit comprises a plurality of microphones.

18. The speech dialog system of claim 11 further comprising a beamformer that combines microphone signals from the plurality of microphones into a single beamformed signal.

19. The speech dialog system of claim 11 where the signal input unit comprises echo cancellation means.

19. The speech dialog system of claim 11 where the signal input unit comprises noise reduction means.

20. The speech dialog system of claim 11 where the signal input unit comprises feedback suppression means.

21. The speech dialog system according to claim 11 where the output unit further comprises a memory for storing at least one predetermined output signal.

22. The speech dialog system according to claim 11 where the output unit further comprises a speech synthesizer for generating speech output signals.
